(19) United States
(12) Patent Application Publication
(10) Pub. No.: US 2010/0040788 A1
(43) Pub. Date: Feb. 18, 2010

(54) GLASS AND CERAMIC OBJECTS HAVING A COATING RESEMBLING A METALLIC COATING

(76) Inventor: Patricia P. McClendon, Shreveport, LA (US)

Correspondence Address: PASSE' INTELLECTUAL PROPERTY, LLC, 1717 BRASSFIELD RD., RALEIGH, NC, 27614, US

(21) Appl. No.: 12/191,720

(22) Filed: Aug. 14, 2008

(51) Int. Cl. B05D 3/02; C09C 1/62

(52) U.S. Cl. 427/376.6; 106/415

(57) ABSTRACT

The present invention relates to a composition for coating vitreous and non-vitreous surfaces such as ceramics, metals, and glass for providing a coating with the appearance and color of actual metals such as copper, gold, silver and stainless steel.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method and product for producing a metallic looking decoration on glass or glazed and unglazed porcelain that can be fired at high temperatures. Specifically, the present invention relates to combination of flux and a metallic looking luster pigment that resembles actual metallic coatings that can be fired at high temperatures and resembles real metallic coatings.

2. Description of Related Art

Luster pigments have a very specific and unique look to them because of their high pearlescence. They are preferred as coatings because of this look. They are typically found in automotive paints, printing inks, plastic bottles, cosmetics and simulated pearls. One type of luster paint is the inorganic platelet particle with a metal oxide coating, such as described in U.S. Pat. Nos. 3,331,699; 5,366,763 and 5,747,153.

Use of the luster pigments in vitreous compositions, however, has been limited. Vitreous compositions, per se, are well known. They are based on ground glass, glass forming materials or a mixture of both. Such compositions can be coatings that are applied to a substrate and then heated or fired to a temperature sufficient to cause the coating components to melt. When cooled, a thin coating of glass is formed on the substrate. The coatings are commonly referred to as vitreous enamels when the substrate is a metal and vitreous glaze when the substrate is a ceramic. The coatings are used to decorate the substrate with color or artistic renditions as well as add to the substrate's durability in terms of scratch and mar resistance, moisture barrier, etc.

The instability problem of luster pigments in vitreous compositions, including coatings and substrate bodies is recognized. U.S. Pat. No. 5,022,923 acknowledges the problem and suggests a solution. The described pigments are provided with a top coating of tin dioxide and/or cerium dioxide. Necessarily, the specially treated luster pigments are more expensive. Additionally, while more stable, their stability is less than ideal. Certain applications of the disclosed luster pigments still do not result in the desired appearance. Furthermore, when the luster pigments are incorporated in a vitreous flux, an inordinate amount of luster pigment is required to obtain proper color intensity. Another drawback is the fact that transparent fluxes must be used for the desired color effects.

Yet another problem is shown in example 7 of U.S. Pat. No. 5,366,763. Therein it is taught that use of flux, while good for incorporating the color, deadens the luster of the pigment when using the platelet particle luster compositions. When testing with 10% flux in the mixture, the appearance of the pigment in terms of a luster rating is described as significantly diminished when compared to use at low temperature without flux. Accordingly, these pigments must be used at lower temperatures and cannot accomplish the coatings that can be accomplished with flux. Further, the well incorporated pigments normally associated with flux inclusion are not available with luster pigments of the platelet type particle.

### BRIEF SUMMARY OF THE INVENTION

The present invention relates to the discovery that platelet type luster pigments of the type that mimic metals, when combined with flux greater than about 25% of the composition up to about 75% of the composition, do not lose their luster and in fact mimic actual metals in their luster and appearance. This discovery is surprising since the prior art teaches that when combined with 10% flux, the compositions lose their luster and shine and are not acceptable products.

In one embodiment of the invention there is a composition for creating a metallic appearing coating on a vitreous or non-vitreous surface comprising:
a) about 25% to about 75% of a clear vitreous flux;
b) about 25% to about 75% of an inorganic luster pigment having a platelet particle and resembling a metallic coating.

In yet another embodiment of the invention there is a method of producing a durable coating on a smooth vitreous or non-vitreous surface resembling a metallic coating comprising:
a) mixing about 25% to about 75% of a clear vitreous flux with about 25% to about 75% of an inorganic luster pigment having a platelet particle and resembling a metallic coating in a carrier liquid;
b) applying a coating to at least a portion of the surface; and
c) firing the coated surface at a temperature of between about 1300 degrees F. and about 1425 degrees F.

### DETAILED DESCRIPTION OF THE INVENTION

While this invention is susceptible to embodiment in many different forms, herein there will be described in detail specific embodiments with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein vitreous or non-vitreous surfaces can be metallic, ceramic or glass in nature. Examples of such surfaces include cast iron, steel, aluminum, copper, silver, gold, porcelain and glass. This includes both vitreous and non vitreous ceramics. Generally, the surface is going to be one that will have the need for addition of decoration that has the appearance of a metal selected from the group of gold, silver, copper and stainless steel or the like to use in place of such metals that are expensive and not necessary for their properties when used as decoration on such surfaces.

The pigments as used herein are inorganic luster pigments having platelet appearing particles. They are combined with the flux as described elsewhere in an amount from about 25% to about 75% of the total composition. In general, these particles have a surface coating of at least one metal oxide layer. The luster pigments of the present invention are inorganic based on their surprising stability and effect at the temperatures of the present invention. They have a temperature stability to deformation of at least about 800 degrees F. Typical representations of such luster pigments are produced by Thompson Enamel and named “Carefree Lusters”. Currently, they can be viewed at www.thompsonenamel.com and, they are also the subject of certain patents including U.S. Pat. Nos. 5,336,763 and 5,747,153. The inability of these compositions to be used with flux is taught in the '763 patent.

The luster pigments used in this invention are inorganic based because of their temperature stability at the temperatures encountered. They have a temperature stability to deformation of at least about 800 degrees F. The pigments are inorganic platelet-like particles with a surface coating of at least one metal oxide layer. The pigments are actually transparent inorganic platelets having a coating of a metal oxide on each of the broad faces of the platelet. The optical contribution is made by the metal oxide layers. Thus, each pigment particle behaves like two metal oxide platelets held together by the particle substrate. The particles typically have a length of from about 1 micron to about 180 microns, a width of from about 1 micron to about 180 microns and a thickness of from about 0.1 microns to about 3 microns. Platelet-like particles include mica and glass. Metal oxides used as the coatings include titanium dioxide, ferric oxide, zinc oxide, zirconium oxide, nickel oxide, cobalt oxide and chromium oxide.

Mica flakes coated with the titanium dioxide, ferric oxide, or a mixture thereof is preferred because of their ready availability. The mica based pigments with a titanium dioxide surface coating are stable to about 1900 degrees Fahrenheit. The mica based pigments with a ferric oxide surface coating are stable to about 2000 degrees Fahrenheit. The later pigments are especially useful on glass in that they fix at a relatively lower temperature and are more intense. The glass based pigments with a titanium dioxide surface coating are stable to about 1500 degrees Fahrenheit and while less stable than the mica based pigments, have more sparkle. Additionally, the glass platelet-like particles of the pigment can be colored with a metal oxide such as the cobalt oxide to enhance the luster effect.

The luster pigments used herein can be stabilized with a top layer of tin dioxide and cerium dioxide as suggested in U.S. Pat. No. 5,022,923. However, the stabilization is not necessary.

As used herein the flux of the present invention is a clear vitreous flux present in an amount from about 25% to about 75% of the composition. In one embodiment the flux is present from about 25% to about 50% of the composition. In yet another embodiment the flux is present from about 35% to about 45%. Flux for ceramic use is well known and is available in a clear formulation. For example, such a flux is available currently from Reusche and Co., 1299 H Street, Greeley, Colo. 80631 as product number 7694MG.

The pigment and flux of the present invention once chosen is mixed in a ratio as desired within the rations taught herein. Because they are both powders, a carrier liquid must be used to wet the composition for use on the desired surface. Carrier agents are well known and for this type of composition are usually some form of organic solvent; however, one carrier liquid that works well with the particular invention is mineral oil. The carrier liquid is mixed with the mixed powders so that a slurry is formed that can be worked with on the desired surface. The composition in the carrier oil is then ready for use.

Initially, the composition in carrier liquid is applied to the vitreous or non-vitreous surface in an effective amount to give the desired appearance. The amount of pigment applied is not critical. Typically, about one gram of pigment per square foot of surface is sufficient to give a satisfactory lustrous appearance for most products. If excess luster pigment on the finished product after firing is to be avoided, the pigment is applied in a controlled amount, e.g. by screen printing to suit a particular surface, luster intensity, and temperature/time firing process. The thinner coats have excellent luster quality at the reflective angle and good transparency at the transmission angles with good gloss. Excessive pigment application is tolerated in that any excess which is not fixed to the surface as further discussed below is simply washed away to leave a surface with the desired pleasing appearance. In the method herein, the composition in carrier liquid can be applied by any convenient method, for example, applied by spraying onto the surface. The pigment dispersed in a carrier liquid is sprayed, brushed or rolled directly onto the surface. In the case of application to a vitreous overglaze, the pigment can be brush-applied onto the overglaze. Alternatively, the overglaze is in the form of a decorative screen print or decal composed of an unfused first layer of frit and a luster pigment layer which is applied to a substrate such that the luster pigment layer is on the surface.

The substrate with its vitreous or non-vitreous surface and surface applied luster pigment liquid is heated to fix the pigment to the surface. The temperature for such fixing is from about 1300 degrees F. to about 1425 degrees F. In one embodiment it is fired at a temperature of between about 1400 and 1425 degrees F. For the wet coatings, the substrate is first heated to dry the coating by driving off the liquid carrier prior to the heating step to fix the pigments. In either case, the surface is heated to a temperature and time sufficient to fix the luster pigment to the surface. The temperature and time needed is dependent on the vitreous or non-vitreous surface but is within the skill in the art.

Once the proper temperature and time have been achieved, the substrate is cooled. The resultant product has a surface coating of the luster pigment fixed to its surface. The pigments are permanently fixed to its surface. The pigments have retained their pleasing metallic appearance.

One pound of color from Thompson Enamel in metallic orange resembling copper is mixed with ¾ pound of clear flux from Reusche product number 7694mb, which contains borates, lead compounds, silica and quartz. It is then mixed with sufficient mineral oil to form a thick free flowing product. The liquid is used to coat glazed porcelain and then fixed at 1422 degrees F. At the end of the fixing period, the product is cooled and the painted on coating has the appearance of real copper. The glazing is repeated with Thompson enamels resembling silver, gold and stainless with similar results.

What is claimed is:

1. A composition for creating a metallic appearing coating on a vitreous or non-vitreous surface comprising:
a) about 25% to about 75% of a clear vitreous flux;
b) about 25% to about 75% of an inorganic luster pigment having a platelet particle and resembling a metallic coating.

2. A composition according to claim 1 which further comprises a carrier liquid.

3. A composition according to claim 2 wherein the carrier liquid is mineral oil.

4. A composition according to claim 1 wherein the luster pigment is selected from the group of colors consisting essentially of copper, gold, silver and stainless steel.

5. A composition according to claim 1 wherein the clear flux comprises borates, lead compounds, silica and quartz.

6. A composition according to claim 1 wherein the flux comprises between about 25% and about 50% of the composition.

7. A method of producing a durable coating on a smooth vitreous or non-vitreous surface resembling a metallic coating comprising:
a) mixing about 25% to about 75% of a clear vitreous flux with about 25% to about 75% of an inorganic luster pigment having a platelet particle and resembling a metallic coating in a carrier liquid;
b) applying a coating of the mixture to at least a portion of the surface; and
c) firing the coated surface at a temperature of between about 1300 degrees F. and about 1425 degrees F.

8. A method according to claim 7 wherein the luster pigment is selected from the group of colors consisting essentially of copper, gold, silver and stainless steel.

9. A method according to claim 7 wherein the surface is fired at a temperature of between about 1400 degrees F. and 1425 degrees F.
